(19) United States
(12) Patent Application Publication
(10) Pub. No.: US 2010/0046024 A1
(43) Pub. Date: Feb. 25, 2010

(54) METHOD FOR THE PRODUCTION OF A FRANKING MARK, AND DEVICE FOR CARRYING OUT SAID METHOD

(75) Inventors: Boris Mayer, Bonn (DE); Thomas Ogilvie, Bonn (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/447,268

(22) PCT Filed: Oct. 8, 2007
(86) PCT No.: PCT/EP2007/008703

§ 371 Date: Aug. 7, 2009

(30) Foreign Application Priority Data
Oct. 27, 2006 (EP) 60622479.7

(51) Int. Cl. G06F 3/12; G06F 17/30

(52) U.S. Cl. 358/1.15; 707/769; 707/E17.108

(57) ABSTRACT

There is provided a method and system for the production of a postage indicium, whereby the postage indicium is made available to an operating unit using an intelligent document. An exemplary method comprises making a query as to whether the postage indicium has already been printed before in response to the document being opened. The exemplary method also comprises checking whether there is access to a network as part of a checking step. The exemplary method additionally comprises printing the postage indicium via a program for controlling printing if a network connection exists between a franking client and a franking server, and if, on the basis of a query to the franking server, it is ascertained that that postage indicium has not been printed before.

### CROSS REFERENCE TO RELATED APPLICATIONS

Pursuant to 35 U.S.C. §371, this application is the United States National Stage Application of International Patent Application No. PCT/EP2007/008703, filed on Oct. 8, 2007, the contents of which are incorporated by reference as if set forth in their entirety herein, which claims priority to European (EP) Patent Application No. 06022479.7, filed Oct. 27, 2006, the contents of which are incorporated by reference as if set forth in their entirety herein.

### BACKGROUND

It is a known procedure from German patent application DE 10 2004 046 051 A1 to use an intelligent document to make postage indicia generated in a central franking server available to an operating unit via a network. Intelligent documents contain not only text elements and graphic elements but also a process logic that makes it possible to change the content of the document and to carry out prescribed processes. In particular, in this prior-art method, the printing of a postage indicium contained in such an intelligent document is logged in a central database and, before the printing procedure, it is ascertained whether this postage indicium has already been printed before. If this is the case, the printing is not permitted, thereby preventing multiple printing of the postage indicium with fraudulent intent. The logging of the printing and the checking steps are carried out by the process logic of the intelligent document, said process logic controlling especially the communication between the operating unit and the central database. In order to execute the process logic, a program execution environment is needed that is contained in a display program that is executed in the operating unit of the customer and that is configured in such a way that it can display and interpret regular documents as well as intelligent documents. An example of such a display program is “Adobe Reader” made by the Adobe Company, whose more recent versions can process conventional PDF documents (PDF: Portable Document Format) as well as intelligent PDF documents.

In the known method, a postage indicium cannot be printed if certain preconditions for the printing have not been met. Thus, for example, the printing cannot be carried out if the operating unit has a version of the display program that is not capable of interpreting intelligent documents or if an appropriate functionality of the display program is not activated. In these cases, even though static contents of the intelligent document can generally be displayed on the operating unit, the functionality of the document for carrying out the necessary database query and for controlling the printing is not available. Furthermore, the network connection between the operating unit and the network can be deactivated so that it cannot be determined whether the postage indicium has already been printed before. In this case, it is likewise not possible to print the postage indicium.

Here, the problem arises that the user does not receive any information about which precondition for the printing of the postage indicium has not been met, since the results of the checking steps indicating whether the preconditions have been met for the use of the functionality of the intelligent document are not displayed. This greatly reduces the probability that the user can autonomously meet the lacking preconditions on his own. This leads to dissatisfaction on the part of the user and to unnecessary service calls to the provider of the postage indicia.

### SUMMARY OF THE INVENTION

An exemplary embodiment of the present invention may provide the ability to carry out a method for franking mailpieces and the ability to configure a device for franking mailpieces in such a way that a high level of operating convenience for a user is combined with a high level of protection against manipulation.

Thus, a method for generating a postage indicium according to an exemplary embodiment of the present invention is carried out in such a way that, before, during or after the opening of an intelligent document containing the postage indicium, it is checked whether the postage indicium has already been printed before.

Furthermore, a method, an intelligent document and a device according to an exemplary embodiment of the present invention are provided in which the intelligent document comprises a program which, when a precondition has been met, can be executed using a program execution environment, said intelligent document containing contents that can be displayed by a display program. A program module may be inserted into the intelligent document, said program module being configured to create displayable information indicating the result of the checking step in order to check whether the precondition has been met within the intelligent document.

The precondition may comprise information as to whether printing has taken place.

Moreover, an intelligent document may be used that comprises a program which, when a precondition has been met, can be executed using a program execution environment and that contains contents that can be displayed by a display program. The intelligent document may be characterized in that it contains a program module that is configured to create displayable information indicating the result of the checking step in order to check whether the precondition has been met within the intelligent document.

Moreover, according to an exemplary embodiment of the present invention, a device is provided for the production of a postage indicium, comprising a structure for providing the postage indicium, using an intelligent document. This device is characterized in that a query is provided for checking whether the postage indicium has already been printed before.

Furthermore, a device is created for producing an intelligent document comprising a program which, when a precondition has been met, can be executed by a program execution environment, said intelligent document containing contents that can be displayed by a display program. The device is configured to insert a program module into the intelligent document, said program module being configured to create displayable information indicating the result of the checking step in order to check whether the precondition has been met within the intelligent document.

An advantage of such an exemplary embodiment of the invention lies in the fact that the intelligent document itself contains a program module with which information indicating the result of a checking step can be generated. In this manner, the intelligent document itself is capable of providing information indicating the result of a checking step, so that the result of the checking step is displayed irrespective of the configuration of the display program.

Displayable information within an intelligent document may be referred to herein as information that can be displayed, for example, on a monitor by the display program. The intelligent documents can contain not only displayable contents but also additional contents such as, for example, program codes that, at least in a normal display mode, are not shown by a display program.

Within the scope of the checking steps, it is advantageously checked whether certain preconditions have been met for the use of the functionality of the intelligent document. If these preconditions have been met, a positive result of the checking step is displayed. If the preconditions have not been met, a negative checking result is displayed, so that the user is informed as to which precondition has not been met. He or she can use this knowledge to meet the precondition in question.

In an exemplary embodiment of the method, of the computer program product, of the intelligent document and of the device, it may be provided for the checking step to be carried out by the program module.

A checking step is advantageously the query as to whether the postage indicium has already been printed before.

In a refinement of the exemplary method, of the exemplary computer program product, of the exemplary intelligent document and of the exemplary device, it may be provided for the query to be transmitted by a franking client.

An embodiment of the method, of the computer program product and of the device is also characterized in that the query is made to the franking server.

However, it is likewise possible and practical for the query to be made to a database that can be connected to the franking server.

A refinement of the exemplary method, of the exemplary computer program product and of the exemplary device comprises that, if the query shows that the postage indicium has not been printed before, then the printing of the postage indicium is made possible.

A refinement of this provides that the printing of the postage indicium is made possible in that a button for a printing procedure for the postage indicium pops up and/or is activated.

Another refinement of the exemplary method, of the exemplary computer program product and of the exemplary device provides that, when the button is actuated, a valid code for the production of a postage indicium is called.

A refinement of the exemplary method, of the exemplary computer program product and of the exemplary device may be characterized in that, when the button is actuated, the valid code is printed.

It is especially preferred that, when the button is actuated, the valid code is called and the valid code is printed.

In an especially preferred exemplary embodiment of the invention, the printing of the valid code corresponds to displayable information about the postage indicium.

In particular, it is advantageous for the program module to be configured in such a way that it produces the displayable information about the postage indicium.

Advantageously, the program module in this exemplary embodiment is also configured to execute the checking step so that the intelligent document can check itself independently of the specific configuration of the display program.

A refinement of the exemplary method, of the exemplary intelligent document and of the exemplary device is characterized in that, during a checking step, it is checked whether the program execution environment is available.

This refinement has the advantage that, if applicable, the user can be informed that the program execution environment is not present and thus that certain functions of the intelligent document are not available.

If the program execution environment is not available, however, the checking step cannot be performed directly by the execution of a program. By the same token, the information indicating a negative result of the checking step cannot be incorporated into the intelligent document by the program module.

Moreover, an exemplary embodiment of the device may be characterized in that the device is configured to incorporate displayable information into the intelligent document indicating a negative result of the checking step, and in that the program module is configured to convert the displayable information indicating the negative result of the checking step into information indicating a positive result of the checking step.

In this exemplary embodiment, the checking as to whether the program execution environment is present, can advantageously be carried out implicitly by the program module, which creates the information indicating the result of the checking step within the intelligent document. This is achieved in that, through the execution of the program module, which can only occur if the program execution environment is available, information indicating a positive result of the checking step is created by converting information indicating a negative result of the checking step already present in the intelligent document. If the program execution environment is not available, the program module cannot be executed and the information indicating the negative result of the checking step is retained.

In a refinement of the exemplary method, of the exemplary intelligent document and of the exemplary device, it may be provided that the program controls the one-time printing of a postage indicium and that the intelligent document is transmitted from a franking server via a network to a franking client.

The method, the intelligent document and the device according to an exemplary embodiment of the present invention may also be characterized in that, when the postage indicium is printed for the first time, a message is transmitted from the franking client to the franking server and in that, on the basis of this message, the printing is logged in the franking server.

In an exemplary embodiment of the method, it is possible for users having a special authorization—e.g. administrators and/or employees of the customer service—to reset the printing result that has been logged in the franking server, so that the customer can once again launch the printing.

Moreover, in an exemplary embodiment of the method, of the intelligent document and of the device, it may be provided that the program for controlling the printing of the postage indicium can only be executed if a network connection exists between the franking client and the franking server, and when, on the basis of a query to the franking server, it is ascertained that that postage indicium had not been printed before.

This prevents a postage indicium that has been paid for once from being printed out multiple times.

An exemplary embodiment of the method, of the intelligent document and of the device may be characterized in that, during the checking step, it is checked whether there is access to the network.

Moreover, a refinement of the exemplary method, of the exemplary intelligent document and of the exemplary device entails the fact that, during the checking step, a query to the franking server is made in which it is checked whether contents of the intelligent document have already been printed before.

Another exemplary embodiment of the method, of the intelligent document and of the device may include the program execution environment as a component of the display program.

Moreover, a computer program product according to an exemplary embodiment of the present invention is provided that contains a computer program for executing a method of the type described above.

An exemplary embodiment of the present invention comprises the case in which the computer program is executed on different data processing units as well as the case in which it is executed on a single data processing unit.

As used herein, the term “computer program” is not intended to be construed in any limiting fashion whatsoever. In particular, it includes all types of executable program instructions.

Moreover, the term “computer program” also includes the use of several computer programs.

It is advantageous for at least one computer program to be present in the intelligent document. It may be especially advantageous for this computer program to influence and/or control several or all of the method steps presented.

In particular, it may be advantageous for the program contained in the intelligent document to be configured in such a way that it influences a query.

A refinement of the exemplary method, of the exemplary computer program product and of the exemplary device provides that query generator interacts with the operating unit.

These and additional advantages, special features and practical refinements of exemplary embodiments of the invention are also elucidated below making reference to FIG. 1.

### BRIEF DESCRIPTION OF THE DRAWING

FIG. 1 is a block diagram of a franking client that is connected to a server from which intelligent documents can be transmitted to the franking client according to an exemplary embodiment of the present invention.

### DETAILED DESCRIPTION OF SPECIFIC EMBODIMENTS

The invention relates to a method for the production of a postage indicium, whereby the postage indicium is made available to an operating unit using an intelligent document.

The invention also relates to a device for carrying out said method.

Below, exemplary embodiments of the present invention will be explained on the basis of examples of individual forms of intelligent documents:

An exemplary embodiment of the intelligent documents comprises the use of envelopes in PDF formats of the type offered, for example, by the Adobe software company.

Such documents can be opened, read and processed using appropriate programs. Acrobat Reader is especially well-suited for this purpose.

The application uses, for example, one, several or all of the following JavaScript functions for the dynamic query to the license server out of Acrobat Reader:
app.viewerVersion: for checking the Reader version.
SOAP.*: to check for an Internet connection.
document.getField(“field name”).display=display.hidden/display.visible: for fading in and out “sample” overprints
document.print ({bUI: true, nStart: 1, nEnd: 1, bSilent: true, bAnnotation: true}) or document.print ({bUI: false, nStart: 1, nEnd: 1, bSilent: true, bAnnotation: true}) for directly printing the document without user interaction.
The actual PDFs to be printed are stored as annotation form fields (originally for visual feedback—e.g. when a button is pushed—in order to distinguish between the printed and non-printed states) and only switched to “visible” immediately before the printing.
Barcode fields. The Acrobat Reader supports form fields that display an appropriate barcode for a value (as a rule, numerical value).
As an alternative, special fonts that are embedded in the document can be used for barcode fields.
For barcode types that Acrobat Reader does not support internally or through additional fonts, the barcode can be downloaded as a bitmap image via an external URL. For this purpose, a servlet service that generates and makes available the appropriate bitmap would have to be implemented in the application.

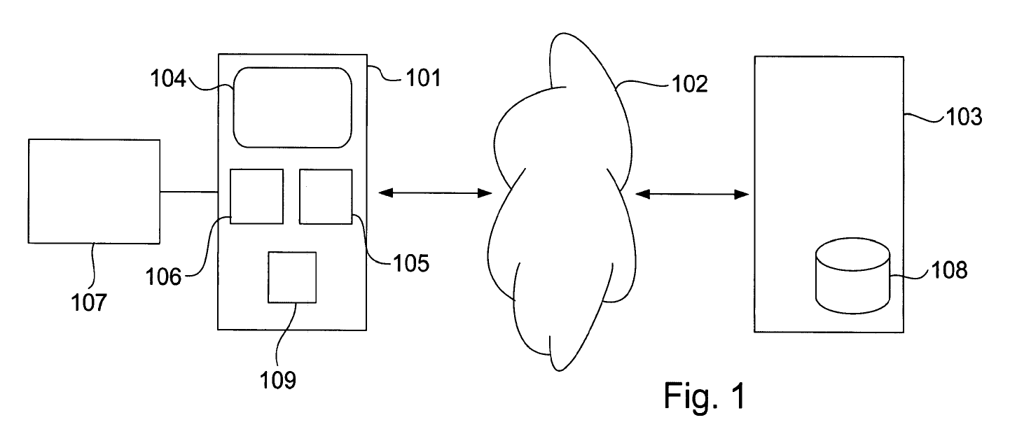

FIG. 1 schematically shows a franking client 101 that is connected to a server 103 via a network 102. The network 102 is, for example, the Internet or an intranet. The franking client 101 is, for example, a PC (personal computer) that has a display device 104 and at least one input device 109 as well as a memory 105 and a processor 106. In particular, a display program is stored in the memory 105; this program can be executed in the franking client 101 and it can open conventional documents having a certain format such as, for example, PDF documents, and can display their contents on the display device 104. Moreover, the display program allows the processing of intelligent documents, that is to say, it is configured to display displayable contents of intelligent documents on the display device 104, and to execute programs that are contained in the intelligent documents. For this purpose, the display program provides a program execution environment with which program commands contained in the programs can be interpreted and executed. Moreover, the franking client 101 is connected to a printing device 107 via an interface and it has a network interface for purposes of connecting to the network 102.

Intelligent documents are transmitted from the server 103 via the network 102 to the franking client 103. For this purpose, the server 103 has a means configured, for example, as a software program, in order to create intelligent documents. In an exemplary embodiment of the present invention, the server 103 is configured as a franking server that provides intelligent documents for the printing of postage indicia. In such an exemplary embodiment, the server 103 comprises a database 108 with one entry for each postage indicium that has been generated and transmitted to a franking client 101.

The intelligent documents comprise contents that can be displayed on the display device 104 by the display program and that consist of text elements and/or graphic elements. Furthermore, programs that can be executed by the program execution environment are embedded into the intelligent documents. These programs are scripts that comprise the program code that can be interpreted by the program execution environment. Displayable contents of the intelligent documents can be changed using the programs. Moreover, the programs allow the execution of additional processes such as, for example, the actuation of the printing device 102 for printing contents of the intelligent document, or for accessing the network interface. In the normal display mode of the display program, the program code is not displayed on the display device 104. Fundamentally, however, the display program can have a special display mode in which the program code can also be displayed.

Within the scope of an exemplary embodiment of the present invention, an intelligent document provided by the server also contains status information indicating the result of one or more checking steps. Here, displayable information indicating the checking results is created by one or more program modules that are likewise contained in the intelligent document. The program modules can be configured as autonomous programs or they can be part of a program that is provided for the execution of the main functionality of the intelligent document. Within the scope of the checking steps, it is ascertained whether certain preconditions for the use of the main functionalities of the intelligent document have been met. In this manner, in the eventuality of an unusable functionality, the user especially is informed about a precondition that might not have been met. He or she can use this knowledge to meet the precondition and thus to use the functionality of the intelligent document.

A precondition for the use of the functionality of an intelligent document comprises the availability of the program execution environment. As a rule, however, not all display programs for displaying documents in the format of the intelligent document have a suitable program execution environment. Thus, the program execution environment might not be present, for example, in older versions of the display program. Therefore, in an exemplary embodiment, a checking step especially checks whether the display program of the franking client 101 has a program execution environment that is suitable for executing the program contained in the intelligent document. In order to be able to correctly display the result of this checking step even if the program execution environment is not present, displayable information indicating a negative result of the checking step is already incorporated into the document at the time when the intelligent document is created. Furthermore, a program module is inserted into the intelligent document and this program module—when it is executed—converts information indicating the negative result of the checking step into information indicating a successful execution of the checking step. The intelligent document is preferably configured in such a way that, after said intelligent document has been opened in the display program, the program module is automatically started if the program execution environment is present.

Therefore, immediately after the intelligent document has been opened in the display program, the information indicating the negative checking result is displayed. This occurs irrespective of whether the program execution environment is available or not. If the program execution environment is available, the program module is started after the intelligent document has been opened. On the basis of the execution of the program, the information indicating the negative result of the checking step, i.e. the information indicating that the program execution environment is not available, is converted into information indicating a positive result of the checking step. If the program execution environment is not available, the program module cannot be executed, and the information indicating the negative result of the checking step is retained in unchanged form. Checking whether the program execution environment is available is thus carried out implicitly, and this yields a positive or negative result, depending on whether the program module can be executed or not.

In addition to this checking step, in which a decision is made about the presence of the program execution environment, by the same token, other checking steps can be executed by a program contained in the intelligent document. The results of these checking steps can then be displayed in the same manner in that information indicating a negative result is converted into information indicating a positive result by a program module.

The conversion of the information indicating the negative result of the checking step into the display of a positive result of the checking step can be done by changing the information. For example, one or more characters can be added to the negative information in order to create information indicating a positive result of the checking step. Moreover, the status information can be configured, for example, to be colored. The information indicating the negative result of the checking step can be converted into information indicating a positive result by a color change that is effectuated by the program.

Furthermore, it can also be provided that characters or symbols of the information indicating the negative result of the checking result are at least partially replaced by characters or symbols such that a positive result of the checking step is displayed.

This makes it possible to carry out the method for the production of a postage indicium according to an exemplary embodiment of the present invention in an especially reliable and manipulation-proof manner, whereby the postage indicium is made available to an operating unit using the intelligent document.

In order to ensure that, when the document is opened, a query is made as to whether the postage indicium has already been printed before, it may be advantageous for the query to be transmitted by a franking client 101.

In particular, an exemplary embodiment of the present invention may provide a system that further increases security against manipulation in that the query is made to the franking server 103.

A high level of security against manipulation can be achieved in that the query is made to a database that can be connected to the franking server 103.

In this case, it may be advantageous to arrange the database in a protected area of a data processing system. This translates into an especially secure and reliable query.

In a refinement of an exemplary embodiment of the present invention, the evaluation of the query is carried out in such a way that, if the query shows that the postage indicium has not been printed before, then the printing of the postage indicium is made possible.

A refinement of the exemplary method, of the exemplary intelligent document and of the exemplary device that is suitable for carrying out the exemplary method provides that the printing of the postage indicium is made possible in that a button for a printing procedure of the postage indicium pops up and/or is activated.

In a refinement of an exemplary embodiment of the present invention, it is provided that, after the printing has been carried out, the button for a printing procedure of the postage indicium is deactivated and/or fades away.

In order to be able to print a postage indicium, in a refinement of an exemplary embodiment of the present invention, it is especially desirable for
the display program to have a program execution environment for executing programs that are embedded in the intelligent document,
the franking client 101 to be connected to the network 102 and the programs can access said connection and
the database not to contain a record of the printing of the postage indicium.

Therefore, preferably when the intelligent document is opened, checking steps are executed in which it is checked whether the above-mentioned preconditions have been met.

In an exemplary embodiment of the invention, the results of these checking steps are displayed in the intelligent document in a status display.

In an exemplary embodiment of the present invention, the status display contains a status field for the information indicating the result of the checking as to whether the program execution environment is available, it contains a status field for the information indicating the result of the checking as to whether a network connection exists, and it also contains a status field for the information indicating the result of the checking as to whether the postage indicium was already printed before. At first, the intelligent document provided by the server 103 contains the status display which comprises at least the information indicating a negative result of the first checking step in which the presence of the program execution environment is checked. The results of the other checking steps—in which the connection of the franking client 101 to the network 102 and the presence of the record of the printing in the database of the server 103 are checked—are preferably likewise displayed negatively. Fundamentally, this information can also be incorporated into the document in neutral form and, after the execution of the checking steps, it can be converted into a positive or negative checking result, depending on the outcome. However, the fact that, at first, information indicating negative checking results is present in the document, especially has the advantage that the status information indicating these checking steps behaves in the same manner as the information indicating the results of the checking as to whether the program execution environment is present.

After the intelligent document has been opened in the display program of the franking client 101, the checking steps are executed consecutively. After the successful execution of the checking steps, the appertaining information indicating the negative checking result may be converted in the status display into information indicating positive checking results. Moreover, after the successful execution of a checking step, the next checking step is started. In particular, the intelligent document contains a program module with which, as already described above, the information indicating the negative result of the checking that is contained in the status field as to whether the program execution environment is present is converted into a positive checking result.

Subsequently, by the same program module or another program module, it is ascertained whether access to the network 102 exists in that, for example, a query is sent to the server 103. If a response to this query is received, the network connection exists, and the appertaining information in the status field is converted into information indicating a positive result of the checking step. Furthermore, the database 108 of the server 103 is queried via the network 102 by a program module present in the intelligent document in order to ascertain whether the postage indicium has already been printed out before. If this is not the case, then the appertaining information in the status field is converted into information indicating a positive result of the checking step. Moreover, the button for initiating the printing of the valid postage indicium is made visible or activated in such a way that it can be actuated by the user.

Furthermore, in an exemplary embodiment of the intelligent document, it is provided that the successful execution of all checking steps is indicated by the letters “OK” which are likewise incorporated by a program into the intelligent document as displayable content once the last checking step has been successfully executed. This display can optionally be effectuated in such a way that the customer either receives confirmation in case of a positive checking, for example, in the form of the letters “OK”, or that the positive checking is not visible to the customer and the negative checking result only pops up if the checking was negative.

If a checking step could not be executed successfully, then the subsequent checking steps are preferably no longer executed. On the basis of a displayed negative result of a certain checking step, the user is informed about the absence of a precondition for the franking of a mailpiece by the intelligent document. Thus, the user is given the possibility to take measures in order to meet the appertaining preconditions. In the case of information indicating a negative result of the checking as to whether the program execution environment is available, the user can install, for example, a version of the display program on the franking client 101 containing the program execution environment. In the case of information indicating a negative result of the checking as to whether a network connection is present, the user can, for example, activate the network connection. If a negative result of the checking as to whether the postage indicium has already been printed out before is displayed, then the user knows that he or she cannot print out the postage indicium again, and so he or she can request a new postage indicium from the server 103.

A refinement of an exemplary embodiment of the present invention provides that, if the button is actuated, a call is made and a valid code is printed for purposes of producing the postage indicium.

An additional refinement for reducing the risk of manipulation provides that the actuation of the button for printing the postage indicium does not open a complete printing menu that would offer the user, for example, the possibility to redirect the printing into a file and thus potentially to make it reproducible. Instead, within the program execution environment, the printer (or several printers) connected to the user computer is automatically displayed and/or the customer has the possibility to abort. This ensures that only a direct print-out is permitted without the possibility of redirecting the postage indicium, for example, into a file, as a result of which it is ensured that the postage indicium can only be printed one time.

In a refinement of the exemplary method, of the exemplary intelligent document, of the device and of an exemplary graphic user interface of a data processing system—especially the operating unit—the operating friendliness can be increased in that the valid code is printed when the button is actuated.

A high level of independence from user systems can be achieved in that the program module is inserted into the intelligent document.

In order to further increase the operating friendliness, the program module may be configured in such a way that it produces the displayable information about the postage indicium.

A fast and reliable execution of the program is ensured in this manner.

Advantageously, the program is configured in such a way that it controls a one-time printing of the postage indicium.

A refinement of the exemplary method, of the exemplary computer program product and of the exemplary device provides that the intelligent document is transmitted from a franking server 103 via a network 102 to a franking client 101.

In order to especially effectively prevent the fraudulent production of postage indicia, at the time of the first printing of the postage indicium, a message is transmitted from the franking client 101 to the franking server 103.

In order to further prevent the fraudulent production of postage indicia, the printing of the postage indicium may be logged. In an especially preferred embodiment of the invention, this is done on the basis of a message transmitted from the franking client 101 to the franking server 103.

In order to further increase data security, the exemplary method is carried out or the exemplary device is configured in such a way that the program for controlling the printing of the postage indicium can only be executed if a network connection exists between the franking client 101 and the franking server 103, and if it is ascertained on the basis of a query to the franking server 103 that the postage indicium has not been printed before.

The exemplary embodiments shown and described combine a high level of user friendliness with a likewise very high data level of security. Therefore, they constitute the best method for carrying out the invention. However, it is likewise possible to attain the advantages achieved by the invention with measures having an equivalent effect.

### LIST OF REFERENCE NUMERALS

101 franking client
102 network
103 server
104 display device
105 memory
106 input processor
107 printing device
108 database
109 input device

1-27. (canceled)

28. A method for the production of a postage indicium, whereby the postage indicium is made available to an operating unit using an intelligent document, the method comprising:
making a query as to whether the postage indicium has already been printed before in response to the document being opened;
checking whether there is access to a network as part of a checking step; and
printing the postage indicium via a program for controlling printing if a network connection exists between a franking client and a franking server, and if, on the basis of a query to the franking server, it is ascertained that that postage indicium has not been printed before.

29. The method recited in claim 28, comprising transmitting the query using a franking client.

30. The method recited in claim 28, comprising making the query to a franking server.

31. The method recited in claim 28, comprising making the query to a database that can be connected to a franking server.

32. The method recited in claim 28, comprising enabling printing of the postage indicium if the query shows that the postage indicium has not been printed before.

33. The method recited in claim 32, comprising enabling printing of the postage indicium by activating or displaying a button for a printing procedure of the postage indicium.

34. The method recited in claim 33, comprising deactivating or removing the display of the button after printing the postage indicium.

35. The method recited in claim 33, comprising calling and printing a valid code for the production of the postage indicium in response to activation of the button.

36. The method recited in claim 33, comprising enabling printing of the postage indicium only for pre-selected printers by activating or displaying a button for a printing procedure of the postage indicium.

37. The method recited in claim 33, comprising printing a valid code in response to activation of the button.

38. The method recited in claim 28, comprising inserting a program module into the intelligent document.

39. The method recited in claim 38, comprising producing displayable information about the postage indicium with the program module.

40. The method recited in claim 28, comprising determining whether a predetermined condition has been met as at least part of the checking step.

41. The method recited in claim 40, comprising performing the query as to whether the postage indicium has already been printed before as part of the checking step.

42. The method recited in claim 28, comprising performing another checking step.

43. The method recited in claim 28, wherein the checking step is performed by a program module.

44. The method recited in claim 28, comprising checking whether a program execution environment is available as at least part of the checking step.

45. The method recited in claim 28, wherein the program controls a one-time printing of a postage indicium and wherein the intelligent document is transmitted from a franking server via a network to a franking client.

46. The method recited in claim 28, comprising:
transmitting a message from a franking client to a franking server when the postage indicium is printed for the first time; and
logging the printing on the franking server in response to the message.

47. The method recited in claim 28, comprising querying a franking server to determine whether contents of the intelligent document have been printed before as part of a checking step.

48. The method recited in claim 28, wherein a program execution environment is a component of a display program that displays displayable information from the intelligent document.

49. A tangible, machine-readable medium that stores machine-readable instructions that are executable by a computer to produce a postage indicium, whereby the postage indicium is made available to an operating unit using an intelligent document, the tangible, machine-readable medium comprising:
machine-readable instructions that, when executed by a computer, make a query as to whether the postage indicium has already been printed before in response to the document being opened;
machine-readable instructions that, when executed by a computer, check whether there is access to a network as part of a checking step; and
machine-readable instructions that, when executed by a computer, print the postage indicium via a program for controlling printing if a network connection exists between a franking client and a franking server, and if, on the basis of a query to the franking server, it is ascertained that that postage indicium has not been printed before.

50. A device for the production of a postage indicium, comprising:
means for providing the postage indicium, using an intelligent document;
means for querying to check whether the postage indicium has already been printed before;
means for querying to check whether access to a network exists; and
means for allowing the printing of the postage indicium if a network connection exists between a franking client and a franking server.

51. The device recited in claim 50, wherein the intelligent contains a program configured to control the means for querying.

52. The device recited in claim 50, wherein the means for querying interacts with an operating unit.
